(19) United States
(12) Patent Application Publication
(10) Pub. No.: US 2026/0309037 A1
(43) Pub. Date: Oct. 8, 2026

(54) ASSEMBLY FOR MAINTAINING AND RETAINING A GAS TURBINE ENGINE COMPONENT

(71) Applicant: RTX CORPORATION, Farmington, CT (US)

(72) Inventors: Christian X. CAMPBELL, West Hartford, CT (US); Robert A. WHITE, III, Meriden, CT (US); Bryan P. DUBE, Suffield, CT (US); David Dwyer WHITTLE, Suffield, CT (US); Thiago B. VIEIRA, Sarasota, FL (US); Joseph WILSON, Jupiter, FL (US); Andrew HAINES, West Palm Beach, FL (US); Samuel Enrique VARGAS VEGA, Palm City, FL (US); Andrew S. MILLER, Marlborough, CT (US)

(73) Assignee: RTX CORPORATION, Farmington, CT (US)

(21) Appl. No.: 19/170,036

(22) Filed: Apr. 3, 2025

(51) Int. Cl. F01D 9/04

(52) U.S. Cl. CPC F01D 9/04; F05D 2240/80; F05D 2300/6033

(57) ABSTRACT

A gas turbine engine comprises a ring comprising an inner ring and an outer ring that define a gas path therebetween; a vane disposed in the gas path and supported by the inner ring and the outer ring, the vane includes an inner platform, an outer platform, and an airfoil section disposed therebetween, wherein the inner ring and the outer ring include one or more of: a flange designed to abut an opposing flange defined by the inner platform, the outer platform or both, and permit axially aftward movement until abutment occurs to achieve a nominal tolerance mode; a contact surface designed to abut an opposing contact surface defined by the inner platform, the outer platform or both, and permit axially aftward movement until abutment occurs to achieve a nominal tolerance mode; and, an angled contact surface designed to abut an opposing angled contact surface defined by the inner platform, the outer platform or both, and permit axially aftward movement until abutment occurs to achieve a nominal tolerance mode.

### CROSS REFERENCE TO RELATED APPLICATIONS

The present application is related to co-pending U.S. patent application Ser. No. ______ (RTX Ref. No. 184126US01/MWZB Ref. No. RTXPW-0118), filed Apr. 3, 2025, as the present application and assigned to the same assignee of record.

### FIELD OF THE INVENTION

The subject matter disclosed herein relates to a gas turbine engine component and, in particular, to an assembly for maintaining and retaining the gas turbine engine component.

### BACKGROUND OF THE INVENTION

Referring to FIG. 1, previous work identified a new way of constraining ceramic matrix composite-containing vanes 10 between two monolithic and continuous ceramic rings 20, 30 for the purpose of mounting and retaining the vanes. Further study and development has revealed that under certain circumstances, single monolithic rings at the inner diameter 20 and outer diameter 30 are not sufficient. Certain use cases for ceramic matrix composites, for instance the ring-strut-ring configuration illustrated in FIG. 1, push the limitations of ceramic matrix composite structure and durability. Moreover, this configuration can be further challenged by the added presence of axial load(s) (as indicated by arrow 25), circumferential load(s), and/or pressure load(s) on the component(s) that also contribute to stress(es).

Consequently, there exists a need for a structural configuration that distributes the axial, circumferential, and/or pressure loads to compensate for the configuration(s) of the prior as well as the limitations of ceramic matrix composite-containing components.

### SUMMARY OF THE INVENTION

The present disclosure is directed, in a first aspect, to a gas turbine engine, comprising: a turbine section disposed about an engine axis, the turbine section including a ring comprising an inner ring and an outer ring that define a gas path therebetween; at least one vane disposed in the gas path and supported by the inner ring and the outer ring, the vane includes a lower platform, an upper platform, and an airfoil section disposed therebetween, wherein at least one of the inner ring and the outer ring include one or more of the following: (i) at least one aft end or fore end designed to abut an opposing surface defined by at least one of the lower platform and the upper platform and permit axially aftward movement until abutment occurs to achieve a nominal tolerance mode, (ii) at least one contact surface designed to abut an opposing contact surface defined by at least one of the lower platform and the upper platform and permit axially aftward movement until abutment occurs to achieve a nominal tolerance mode, and (iii) at least one angled contact surface designed to abut an opposing angled contact surface defined by at least one of the lower platform and the upper platform and permit axially aftward movement until abutment occurs to achieve a nominal tolerance mode.

In further embodiments of the present disclosure, including further embodiments of the above exemplary embodiments, the at least one contact surface protrudes radially-outwardly or radially-inwardly.

In further embodiments of the present disclosure, including further embodiments of the above exemplary embodiments, the at least one angled contact surface protrudes radially-outwardly at an angle with a magnitude of at least 6 degrees from an exterior surface of at least one of the inner ring.

In further embodiments of the present disclosure, including further embodiments of the above exemplary embodiments, the at least one angled contact surface protrudes radially-outwardly at an angle with a magnitude of greater than 0 degrees and less than approximately 45 degrees from an exterior surface of at least one of the inner ring.

In further embodiments of the present disclosure, including further embodiments of the above exemplary embodiments, the angle comprises a magnitude of greater than approximately 8 degrees and less than approximately 15 degrees.

In further embodiments of the present disclosure, including further embodiments of the above exemplary embodiments, the at least one angled contact surface comprises a first region having a rounded contact surface and a second region having a flat contact surface.

In further embodiments of the present disclosure, including further embodiments of the above exemplary embodiments, the inner ring and the outer ring include the at least one angled contact surface.

In further embodiments of the present disclosure, including further embodiments of the above exemplary embodiments, the inner ring includes the at least one angled contact surface and the outer ring includes the at least one contact surface.

In further embodiments of the present disclosure, including further embodiments of the above exemplary embodiments, the inner ring and the opposing flange of the lower platform define a clearance gap.

In further embodiments of the present disclosure, including further embodiments of the above exemplary embodiments, a nominal tolerance mode comprises the at least one angled contact surface of the inner ring contacting the opposing angled contact surface of the lower platform and preventing axially aftward movement.

In further embodiments of the present disclosure, including further embodiments of the above exemplary embodiments, the nominal tolerance mode comprises the at least one angled contact surface of the inner ring comprising a first region having a rounded contact surface and a second region having a flat contact surface, the flat contact surface contacting the opposing angled contact surface and preventing axially aftward movement.

In further embodiments of the present disclosure, including further embodiments of the above exemplary embodiments, a nominal tolerance mode comprises the at least one angled contact surface of the inner ring contacting an opposing angled contact surface of the lower platform, the at least one contact surface of the outer ring contacting an opposing contact surface of the upper platform, and the fore end of the outer ring contacting a flange of the upper platform, the contact achieving cross-corner loading and preventing axially aftward movement.

In further embodiments of the present disclosure, including further embodiments of the above exemplary embodiments, the nominal tolerance mode comprises the at least one angled contact surface of the inner ring comprising a first region having a rounded contact surface and a second region having a flat contact surface, the flat contact surface contacting the opposing angled contact surface and preventing axially aftward movement.

In further embodiments of the present disclosure, including further embodiments of the above exemplary embodiments, a nominal tolerance mode comprises the at least one angled contact surface of the inner ring contacting an opposing angled contact surface of the lower platform, the at least one contact surface of the outer ring contacting an opposing contact surface of the upper platform, and the fore end of the outer ring contacting a flange of the upper platform.

In further embodiments of the present disclosure, including further embodiments of the above exemplary embodiments, the nominal tolerance mode comprises the at least one angled contact surface of the inner ring comprising a first region having a rounded contact surface and a second region having a flat contact surface, the flat contact surface contacting the opposing angled contact surface and preventing axially aftward movement.

In further embodiments of the present disclosure, including further embodiments of the above exemplary embodiments, a nominal tolerance mode comprises the at least one angle contact surface of the inner ring comprising a first region having a rounded contact surface and a second region having a flat contact surface, and the flat contact face and opposing angled contact surface contact each other and prevent axially aftward movement.

In further embodiments of the present disclosure, including further embodiments of the above exemplary embodiments, the gas turbine engine further comprises a compressor section, a combustor in fluid communication with the compressor section and the turbine section.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1, not drawn to scale, is a frontal and cross-sectional view of a ring-strut-ring configuration of the prior art found within a gas turbine engine, not drawn to scale.

FIG. 2, not drawn to scale, illustrates a schematic, cross-sectional view of a gas turbine engine.

FIG. 3, not drawn to scale, illustrates an exemplary structural configuration employing an inner ring with an angled contact surface and a pair of flanges disposed at each aft and fore end, and an outer ring having a flange extending radially-inwardly.

FIG. 4, not drawn to scale, illustrates an exemplary structural configuration employing the inner ring of FIG. 3 and an outer ring also having an angled contact surface.

FIG. 5, not drawn to scale, illustrates another exemplary structural configuration employing the inner ring of FIG. 3 and an outer ring having an angled contact surface at an aft end and a fore end designed to contact a flange of the outer platform.

FIG. 6A, not drawn to scale, illustrates a nominal tolerance scenario.

FIG. 6B, not drawn to scale, illustrates an off-nominal tolerance scenario without a secondary axial stop.

FIG. 6C, not drawn to scale, illustrates an off-nominal tolerance scenario with an aft vane platform flanges that acts as a secondary axial stop.

FIG. 6D, not drawn to scale, illustrates a nominal tolerance scenario with contact on the linear region of the angled contact surface.

FIG. 6E, not drawn to scale, illustrates another off-nominal tolerance scenario with contact on the rounded region of the angled contact surface.

FIG. 7, not drawn to scale, illustrates a wedging condition caused by friction at the angled contact surface of the inner ring.

FIG. 8, not drawn to scale, illustrates an inner ring with a high angle contact surface that reduces contact friction and thereby reduces the wedging condition shown in FIG. 7.

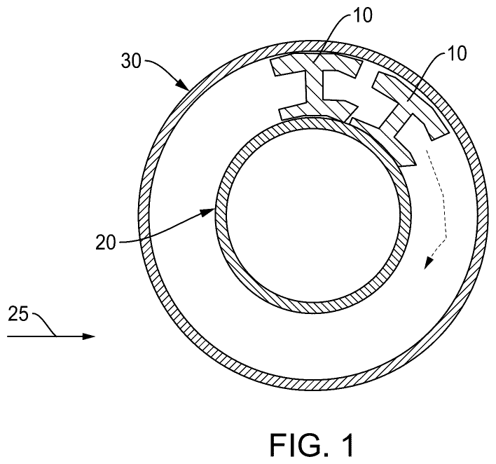

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art. It is to be understood that all concentrations disclosed herein are by weight percent (wt. %.) based on a total weight of the composition unless otherwise indicated.

In the discussion below, axial refers to a direction that coincides with the longitudinal axis of the engine. Radial refers to a direction that is radial with respect to the longitudinal axis of the engine. Circumferential refers to a direction that corresponds to the circumference of a circle around the longitudinal axis of the engine. The leading edge/portion of a structure is the edge/portion that faces in the direction toward the flow of the hot gases, i.e., faces upstream. The trailing edge/portion of a structure is the edge/portion that the faces in the direction away from the flow of the hot gases, i.e., faces downstream.

The present disclosure is directed to a ring-strut-ring configuration encompassing various embodiments incorporating one or more interior diameter rings or one or more outer diameter rings or both. By utilizing a plurality of rings in any one of the various embodiments, the aforementioned loads originating from a vane may be disseminated to the surrounding structure(s) in more direct ways, thus limiting the stress(es) experienced by each individual ring. The exemplary structural configuration overcomes the manufacturing and structural limitations mentioned above with respect to ceramic matrix composite materials, including silicon-containing ceramic materials and composite materials alike.

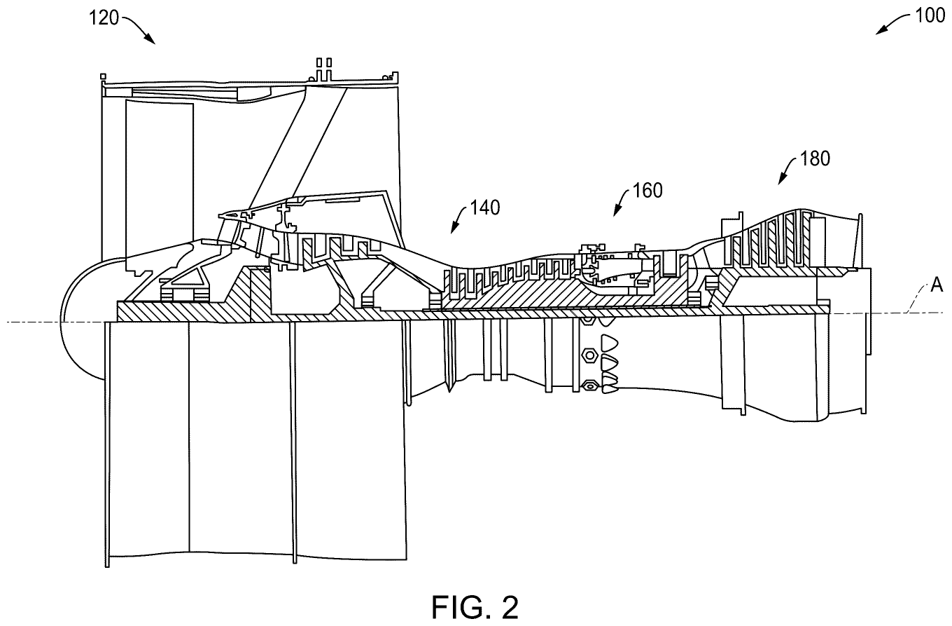

Referring now to FIG. 2, a gas turbine engine 200 is schematically illustrated. The exemplary gas turbine engine 100 is a two-spool turbofan engine that generally incorporates a fan section 120, a compressor section 140, a combustor section 160 and a turbine section 180 about an engine centerline longitudinal axis A. Alternative engines might include an augmenter section (not shown) among other systems for features. The fan section 120 drives air along a bypass flow path in a bypass duct defined within a fan case, while the compressor section 140 drives air along a core flow path for compression and communication into the combustor section 160 then expansion through the turbine section 180. Although depicted as a turbofan gas turbine engine in the disclosed non-limiting embodiment, it should be understood that the concepts described herein are not limited to turbofan engines and these teachings could extend to other types of engines, including but not limited to, three-spool engine architectures.

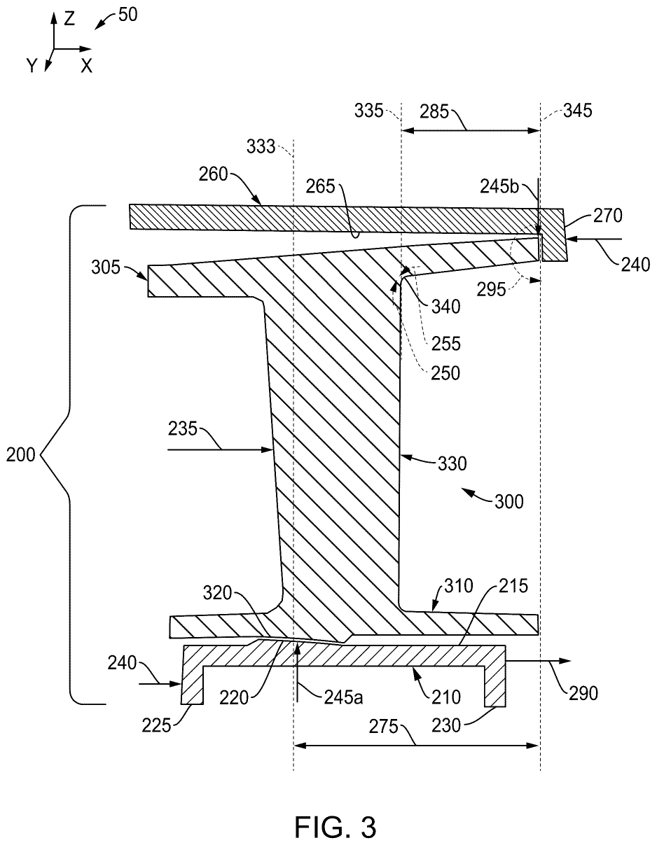

Referring now to FIG. 3, in at least one embodiment, an outer diameter ring 200 may comprise an inner ring 210 and an outer ring 260, and may be concentrically disposed about at least one vane 300, e.g., a row of vanes 300. The inner ring 210 may include a surface 215 having an exemplary angled contact surface 220 and a pair of flanges 225, 230 disposed opposite each other at the forward and aft ends. Each flange 225, 230 may extend radially-inwardly and either one or both may serve a dual role and also act as a retainer that engages the turbine section 180 (not shown in FIG. 3). The angled contact surface 220 may protrude radially-outwardly at an angle with a magnitude of at least 6 degrees from the surface 215 of the inner ring 210. In at least one embodiment, when applying an x-y-z coordinate legend 50 of FIG. 3, the aforementioned angle may be at least negative 6 degrees as measured from the highest point of protrusion of the angled contact surface 220 from the surface 215. In response to the aerodynamic load (as indicated by arrow 235) and axial load (as indicated by arrow 240), the angled contact surface 220 may serve as an axial stop by reacting the radial compressive load (as indicated by arrows 245a, 245b) experienced due to the contact made by the inner ring 210 and the vane 300, and the bending moment experienced as the compressive load forces (as indicated by arrow 250, 255) experienced by the vane(s) 300.

Next, the outer ring 260 may include a surface 265 having a radially-inwardly disposed flange 270 at an aft end. The flange 270 may contact the surface of an upper platform 305 of the vane 300. In response to the radial loads (as indicated by arrows 245a, 245b) and axial load 240, the flange 270 may serve as an axial stop by reacting the bending moment experienced as the compressive load forces (as indicated by arrow 250, 255) experienced by the vane(s) 300. The axial load experienced by outer ring 260 may be reacted to an outer turbine case (not shown). During operation, the various aforementioned pressure loads can be applied to the vane 300 and inner ring 210. In turn, the vane 300 and inner ring 210 can move aftward axially (as indicated by arrow 290). This motion can be stopped by contact with the flange 270 and the vane 300 can pivot (as indicated by arrow 295) about the point of contact. In turn, the axially aftward motion can be stopped by the surface-to-surface contact between the angled contact surface 220 and an opposing angled contact surface 320 of the vane 300.

As illustrated in FIG. 3, the distance measured from a midpoint of the contact between the vane 300 and angled contact surface 220 (as indicated by dashed line 333) to the point of contact between the outer ring 260 and upper platform 305 may be referred to as the wheelbase 275. The forces acting on the wheelbase contact points drive a cross-corner load also being experienced. The distance measured from a point on an aft surface of an airfoil 330 (as indicated by dashed line 335) to the point of contact between the outer ring 260 and upper platform 305 (as indicated by dashed line 345) may be referred to as the lever arm 285. In addition, the opposing points of contact (as indicated by arrows 245a, 245b) between the angled contact surface 220 and opposing angled contact surface 320 and the point of contact between the outer ring 260 and aft end of the upper platform 305 may act as a cross-corner load and prevent motion induced by the aforementioned pressure loads. The cross-corner load (as indicated by arrows 245a, 245b) assists reacting the various pressure loads and reducing the bending moment (as indicated by arrows 250, 255) experienced by the airfoil-platform fillet 340. While the exemplary structural configuration illustrated herein demonstrates improved reaction of the various aforementioned pressure loads during operation, the wheelbase 275 may be enlarged, while the lever arm 285 may be reduced, so that even greater improvement may be achieved.

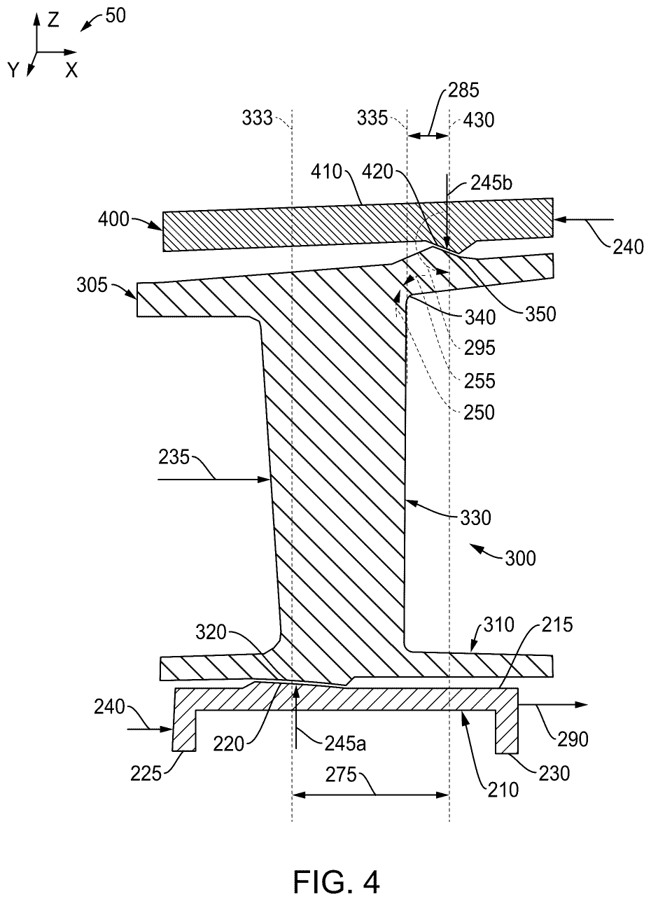

Referring now to FIG. 4, in at least one embodiment, an outer ring 400 may replace the outer ring 260 of FIG. 3, and vane(s) 300 of FIG. 3 may include a second opposing angled contact surface 350 protruding radially-outwardly. The outer ring 400 may include a surface 410 having an angled contact surface 420 protruding radially-inwardly. In at least one embodiment, when applying an x-y-z coordinate legend 50 of FIG. 4, the complimentary angles of the angled contact surface 420 and second opposing angled contact surface 350 may protrude radially-outwardly from the surface 410 of the outer ring 400 or the surface of the upper platform 305 at an angle with a magnitude of greater than 0 degrees. In response to the aerodynamic load (as indicated by arrow 235) and axial load (as indicated by arrow 240), the angled contact surface 420 may serve as an axial stop by reacting the radial compressive load (as indicated by arrows 245a, 245b) and the bending moment experienced as the compressive load forces (as indicated by arrow 250, 255) experienced by the vane(s) 300. As a result, the vane(s) 300 may be constrained and not pivot (as indicated by arrow 290) and move axially aftward due to the contact made between the angled contact surfaces 220, 420 and second opposing angled contact surfaces 320, 350.

As illustrated in FIG. 4, the distance measured from a midpoint of the contact between the vane 300 and angled contact surface 220 (as indicated by dashed line 333) to the point of contact between the outer ring 260 and upper platform 305 may be referred to as the wheelbase 275. The forces acting on the wheelbase contact points drive a cross-corner load also being experienced. The distance measured from a point on an aft surface of an airfoil 330 (as indicated by dashed line 335) to the point of contact between the outer ring 260 and upper platform 305 (as indicated by dashed line 345) may be referred to as the lever arm 285. In addition, the point of contact between the angled contact surface 420 and opposing angled contact surface 350 and the point of contact between the angled contact surface 220 and opposing angled contact surface 320 may act as a cross-corner load and prevent motion induced by the aforementioned pressure loads. The cross-corner load (as indicated by arrows 245a, 245b) assists reacting the various pressure loads and reducing the bending moment (as indicated by arrows 250, 255) experienced by the airfoil-platform fillet 340. In this exemplary embodiment, due to the size of the lever arm 285, the bending moment driven into the airfoil-platform fillet 340 may be relatively low. While the structural configuration illustrated herein demonstrates improved reaction of the various aforementioned pressure loads during operation, an even greater proportion of the wheelbase 275 being utilized may be increased.

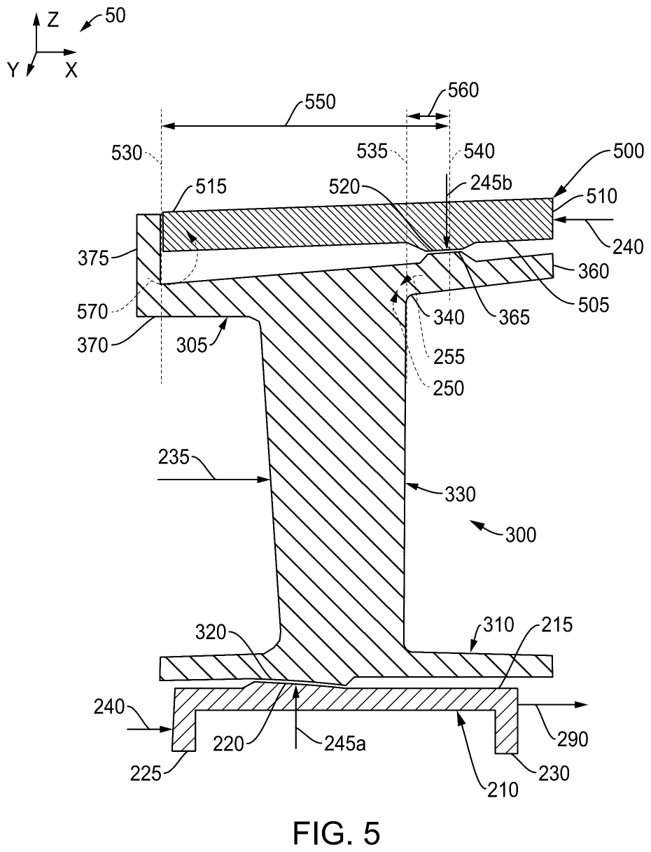

Referring now to FIG. 5, in at least one embodiment, an outer ring 500 may replace the outer ring 260 of FIG. 3, and vane 300 of FIG. 4 having an upper platform 305 that may include an aft end 360 having an opposing raised contact surface 365 extending radially-outwardly, and a fore end 370 having a flange 375 extending radially-outwardly from the surface. The outer ring 500 may include a surface 505 having an aft end 510 and a fore end 515. The surface 505 may include a raised contact surface 520 extending radially-inwardly and designed to abut the opposing raised contact surface 365 of the upper platform 305. Likewise, the fore end 515 may be designed to abut the opposing flange 375 of the upper platform 305. As discussed earlier, the various loads 235, 240, 245a, 245b exert pressure and the vane 300(s) desires to move axially aftward (as indicated by arrow 290). During operation, the flange 375 of vane(s) 300 may contact a fore end 515 of outer ring 500 and acts as an axial stop. As a result, the pivot point 570 can relocate from the aft end 360 of the platform to the fore end 370 where the flange 375 prevents the axially aftward motion. The motion induced by these aforementioned pressure loads can be stopped at the point of contact between the angled contact surface 220 and opposing angled contact surface 320 and the point of contact between the contact surface 520 and opposing contact surface 365. The resultant cross-corner load assists reacting the various pressure loads and reducing the bending moment experienced by the airfoil-platform fillet 340.

To assist preventing or curtailing axially aftward motion, the angled contact surface 220 of the inner ring 210 may exhibit and possess an angle whose slope may facilitate maximum contact and engagement with the opposing angled contact surface 320 of the lower platform 310 as the vane(s) 300 moves axially aftward. In such a configuration, the inner ring 210 does not resist the force exerted by the aerodynamic load 235, but rather adds to the bending moment the vane(s) 300 experiences. Instead, the raised contact surface 520 may resist the aforementioned bending moment. In turn, the bending moment may not be transmitted through the airfoil 330. Rather, the bending moment may be transmitted through the flange 375 and upper platform 305. In at least one embodiment, the raised contact surface 520 and the opposing raised contact surface 365 may be flat, e.g., a slope of 0 (see FIG. 5), or may protrude and exhibit an angle. The aforementioned angle may have a magnitude of greater than 0 degrees from the respective surface of the outer ring 500 and upper platform 305. In at least one embodiment, when applying an x-y-z coordinate legend 50 of FIG. 5, the aforementioned angle may exhibit a positive or negative slope. Although either a positive or negative slope may be utilized, a positive slope may facilitate the flange 375 maintaining contact with the pivot point 570 throughout all gas turbine engine operating conditions. In contrast, the complimentary angles of angled contact surface 220 and opposing angled contact surface 320 may only possess a negative slope and exhibit angles whose magnitude are at least 6 degrees.

As illustrated in FIG. 5, the distance measured from a point of contact between the flange 375 and fore end 515 (as indicated by dashed line 530) to a midpoint of the raised and opposing raised contact surfaces 365, 520 (as indicated by dashed line 540) may be referred to as the wheelbase 550. The distance measured from an aft surface of the airfoil 330 (as indicated by dashed line 535) to the midpoint of the raised and opposing raised contact surfaces 365, 520 (as indicated by dashed line 540) may be referred to as the lever arm 560. In this exemplary embodiment, the lever arm 560 may be relatively small when comparted to the wheelbase 550. In turn, the aerodynamic load 235 may be reacted through the platforms 305, 310, rather than the vane(s) 300 and airfoil 330. In doing so, the platforms 305, 310 of vane(s) 300 may effectively react high bending loads, while the resulting exemplary structural configuration may protect the airfoil-platform fillet 340.

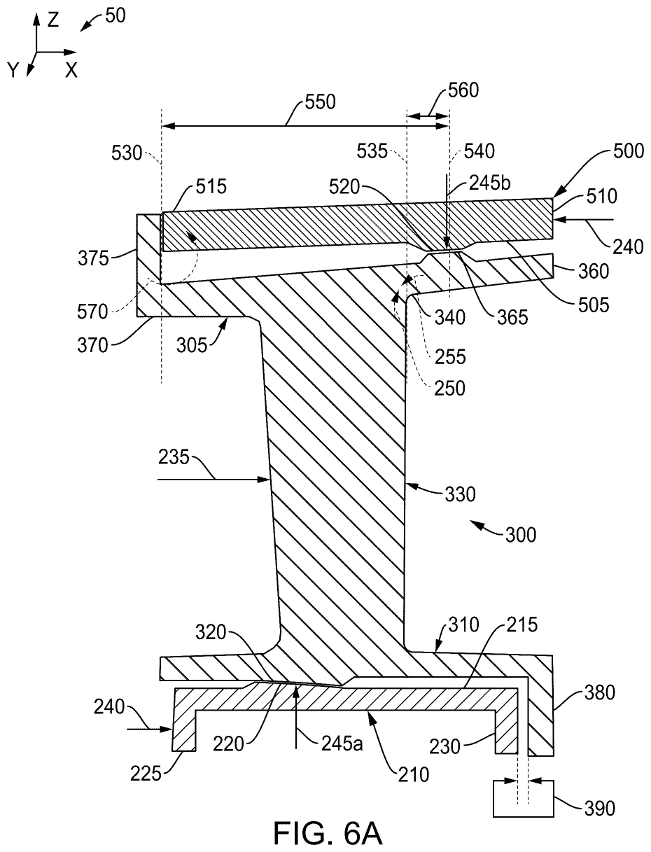

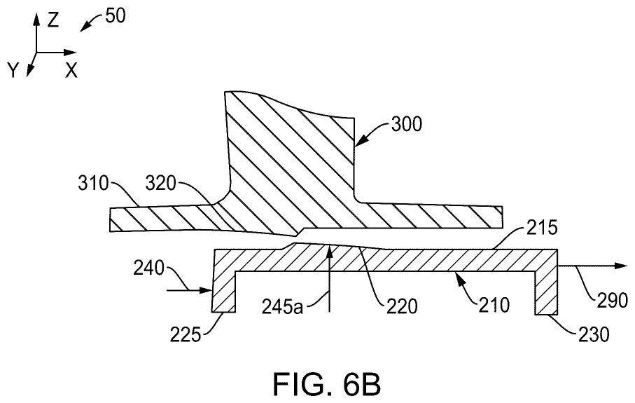

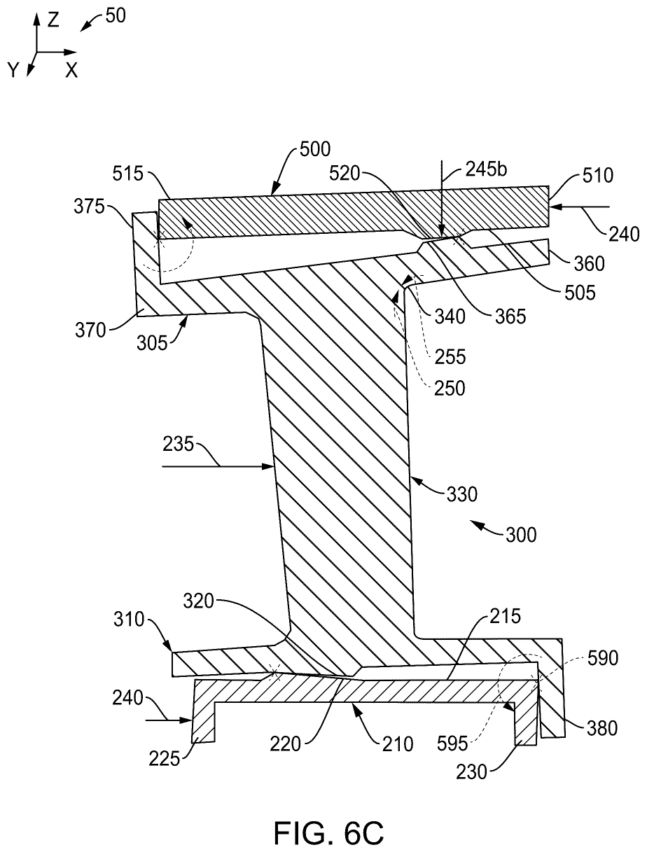

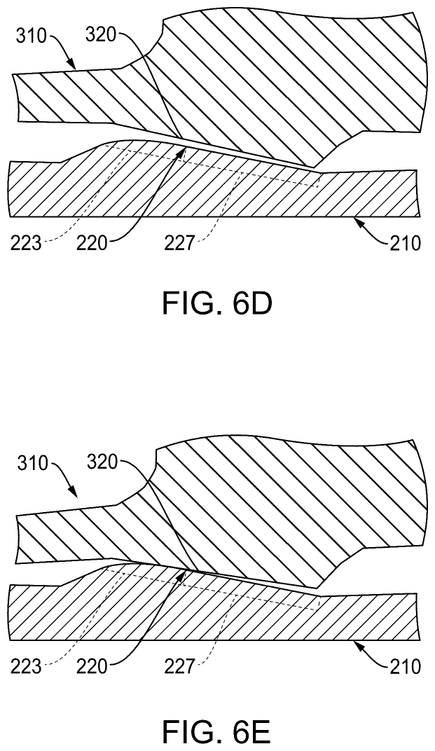

Referring now to FIGS. 6A-6E, in at least one embodiment, an exemplary structural configuration may operate in one of two tolerance modes: nominal tolerance (see FIGS. 6A and 6D) or off-nominal tolerance (see FIGS. 6B, 6C and 6E). In the nominal tolerance mode, the angled contact surface 220 and opposing angled contact surface 320 make contact while a flange 230 of the inner ring 210 does not contact a flange 380 of the vane(s) 300. In turn, the flanges 230, 380 may define a clearance gap 390. In off-nominal tolerance mode, the angled contact surface 220 and opposing angled contact surface 320 may not make contact while the flange 230 of the inner ring 210 contacts the flange 380 of the vane 300(s). The lack of contact between the angled contact surface 220 and opposing angled contact surface 320 may result in the vane 300 moving axially aftward. Without the flange 380 being present, the vane(s) 300 may continue moving axially aftward until contacting a downstream gas turbine engine component(s) (see FIG. 6B). The off-nominal tolerance mode may occur due to various reasons, e.g., tolerance and/or transient conditions. The motion induced by these aforementioned pressure loads can be stopped at the point of contact between the angled contact surface 220 and opposing angled contact surface 320 and the point of contact between the contact surface 520 and opposing contact surface 365. The resultant cross-corner load assists reacting the various pressure loads and reducing the bending moment experienced by the airfoil-platform fillet 340.

When both flanges 230, flange 380 are present and make contact during operation, a new pivot point may form at that point of contact 590 (see FIG. 6C). The aerodynamic load 235, axial load 240, and radial loads 245a, 245b may now induce a counterclockwise rotation (as indicated by arrow 595) about pivot point 590, which may be facilitated due to radial sliding occurring at the contact point between a flange 375 of the upper platform 305 and the fore end 515 of the outer ring 500 (see FIG. 6C). Eventually, as the motion(s) continues, the angled contact surface 220 and opposing angled contact surface 320 make contact and any additional load may be reacted by that aforementioned contact as discussed in the prior exemplary embodiments disclosed herein. Consequently, the exemplary structural configuration may be tolerant to off-nominal conditions, e.g., tolerance and/or transient conditions. However, everyday wear may occur more often. In contrast, under nominal conditions, all the contacts involve surface-to-surface interaction, whereas all the contacts involve point/line loads under off-nominal conditions.

As discussed above, the exemplary structural configuration of FIG. 6A may operate in a nominal tolerance mode or an off-nominal tolerance mode. In at least one embodiment, the interface between the angled contact surface 220 and opposing angled contact surface 320 may influence the tolerance mode being experienced. The angled contact surface 220 may exhibit and possess two different surface regions. In at least one embodiment, the surface may include both a first surface region having a rounded contact face 223 and a second surface region having a flat contact face 227 (see FIG. 6D). As discussed above, the flat contact face 227 of the angled contact surface 220 may facilitate the nominal tolerance mode by contacting the opposing angled contact surface 320. In contrast, when operating under an off-nominal tolerance mode, the rounded contact face 223 may assist distributing the contact load being experienced when the clearance gap 390 closes by contacting the opposing angled contact surface 320 (see FIG. 6E).

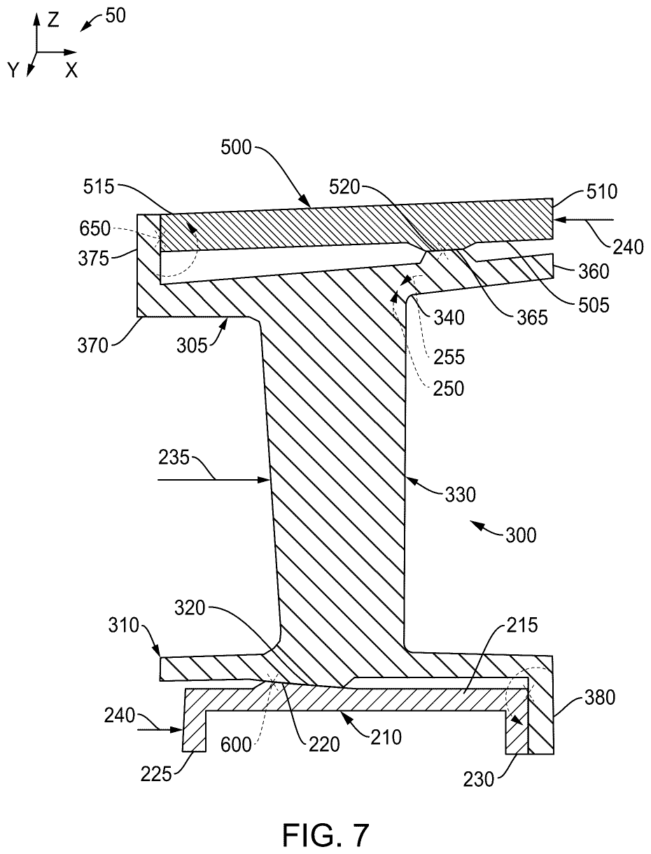

Referring now to FIG. 7, in at least one embodiment, an exemplary structural configuration may address a potential scenario where the inner ring 210 may become wedged in place at a contact point 600. The application of a pressure load on a low angle contact surface may cause the inner ring 210 to become locked due to friction, which is also known as wedging. The inner ring 210 may move axially aftward, contact the flange 380, and become locked. At the same time, the vane(s) 300 may move counterclockwise at the contact point, then may return, in a clockwise motion. When returning, the vane may reach a lower point of motion that the vane 300 must overcome and may likely become locked too. If the inner ring 210 becomes locked, the inner ring 210 may be moved further axially aftward as additional loads, e.g., aerodynamic 235 and axial 240, are repeated and reapplied. These repeated pressure loads may cause ratcheting that may drive an off-nominal stress-state.

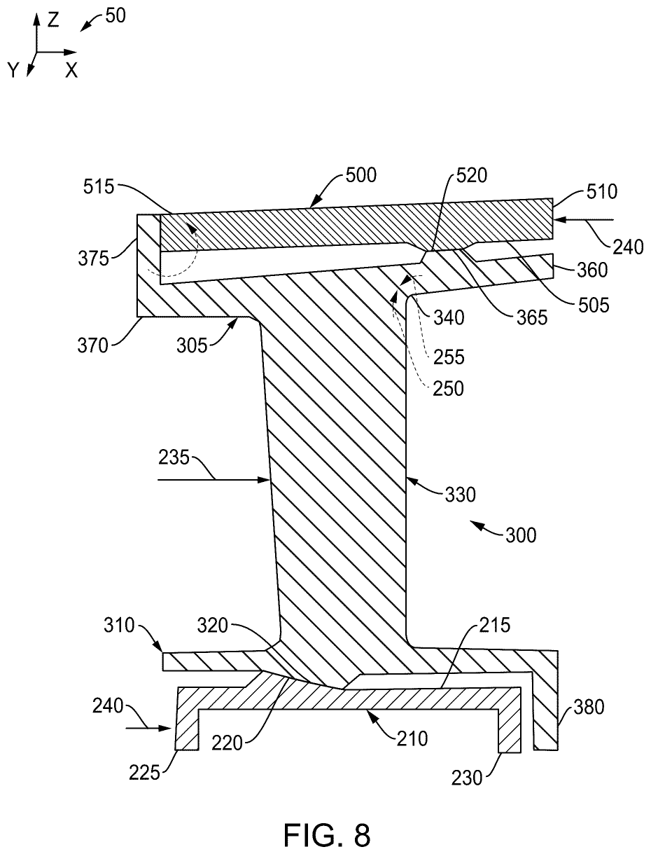

Referring now to FIG. 8, in at least one embodiment, to counteract the potential for wedging the complimentary angles of the angled contact surface 220 of the inner ring 210 and the opposing angled contact surface 320 of the lower platform 310 may be increased. By “increased”, the exemplary embodiments disclosed above may exhibit and possess an angle having a magnitude of at least 6 degrees. In contrast, the exemplary complimentary angles of the angled contact surface 520 and the opposing angled contact surface 365 may have a magnitude of greater than 0 degrees and less than approximately 45 degrees, preferably greater than approximately 5 degrees and less than approximately 18 degrees, and more preferably greater than approximately 8 degrees and less than approximately 15 degrees from the respective surface of the inner ring 210 and lower platform 310, respectively. In at least one embodiment, when applying an x-y-z coordinate legend 50 of FIG. 5, the angle, e.g., angled contact surface 220, may be at least negative 6 degrees as measured from the highest point of the protruding angled contact surface 220 from the surface. Beyond preventing wedging, as well as ratcheting, the aforementioned angle may ensure less uncertainty with respect to the axial position of the inner ring 210 due to dimensional tolerances. As a result, the exemplary structural configuration may operate more frequently utilizing surface-to-surface contact rather than line/point contacts (see FIG. 6C). In turn, at the aforementioned surface-to-surface contact points, the resultant cross-corner load assists reacting the various pressure loads and reducing the bending moment experienced by the airfoil-platform fillet 340.

The exemplary structural configurations disclosed herein effectively reduce the bending moment experienced by the airfoil-platform fillet 340. By supporting the vane(s) with a large wheelbase and providing a small lever arm at the contact point between the platform and vane, the bending moment reduces. The exemplary angled contact surfaces further reduce the bending moment as the radial compression load becomes shared. Further, those same exemplary angled contact surfaces also are resistant to wedge and ratcheting loading disclosed herein. Moreover, as disclosed herein, the exemplary structural configurations are tolerant to off-nominal conditions and, in particular, those off-nominal conditions that affect the inner ring. Lastly, the exemplary structural configurations demonstrate increased certainty in the axial position of the inner ring due to resultant dimensional tolerances.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A gas turbine engine, comprising:
a turbine section disposed about an engine axis, the turbine section including a ring comprising an inner ring and an outer ring that define a gas path therebetween;
at least one vane disposed in the gas path and supported by the inner ring and the outer ring, the vane includes a lower platform, an upper platform, and an airfoil section disposed therebetween,
wherein at least one of the inner ring and the outer ring include one or more of the following:
(i) at least one aft end or fore end designed to abut an opposing surface defined by at least one of the lower platform and the upper platform and permit axially aftward movement until abutment occurs to achieve a nominal tolerance mode,
(ii) at least one contact surface designed to abut an opposing contact surface defined by at least one of the lower platform and the upper platform and permit axially aftward movement until abutment occurs to achieve a nominal tolerance mode, and
(iii) at least one angled contact surface designed to abut an opposing angled contact surface defined by at least one of the lower platform and the upper platform and permit axially aftward movement until abutment occurs to achieve a nominal tolerance mode.

2. The gas turbine engine of claim 1, wherein the at least one contact surface protrudes radially-outwardly or radially-inwardly.

3. The gas turbine engine of claim 1, wherein the at least one angled contact surface protrudes radially-outwardly at an angle with a magnitude of at least 6 degrees from an exterior surface of at least one of the inner ring.

4. The gas turbine engine of claim 1, wherein the at least one angled contact surface protrudes radially-outwardly at an angle with a magnitude of greater than 0 degrees and less than approximately 45 degrees from an exterior surface of at least one of the inner ring.

5. The gas turbine engine of claim 4, wherein the angle comprises a magnitude of greater than approximately 8 degrees and less than approximately 15 degrees.

6. The gas turbine engine of claim 1, wherein the at least one angled contact surface comprises a first region having a rounded contact surface and a second region having a flat contact surface.

7. The gas turbine engine of claim 1, wherein the inner ring and the outer ring include the at least one angled contact surface.

8. The gas turbine engine of claim 1, wherein the inner ring includes the at least one angled contact surface and the outer ring includes the at least one contact surface.

9. The gas turbine engine of claim 8, wherein the inner ring and the opposing flange of the lower platform define a clearance gap.

10. The gas turbine engine of claim 1, wherein a nominal tolerance mode comprises the at least one angled contact surface of the inner ring contacting the opposing angled contact surface of the lower platform and preventing axially aftward movement.

11. The gas turbine engine of claim 10, wherein the nominal tolerance mode comprises the at least one angled contact surface of the inner ring comprising a first region having a rounded contact surface and a second region having a flat contact surface, the flat contact surface contacting the opposing angled contact surface and preventing axially aftward movement.

12. The gas turbine engine of claim 1, wherein a nominal tolerance mode comprises the at least one angled contact surface of the inner ring contacting an opposing angled contact surface of the lower platform, the at least one contact surface of the outer ring contacting an opposing contact surface of the upper platform, and the fore end of the outer ring contacting a flange of the upper platform, the contact achieving cross-corner loading and preventing axially aftward movement.

13. The gas turbine engine of claim 12, wherein the nominal tolerance mode comprises the at least one angled contact surface of the inner ring comprising a first region having a rounded contact surface and a second region having a flat contact surface, the flat contact surface contacting the opposing angled contact surface and preventing axially aftward movement.

14. The gas turbine engine of claim 1, wherein a nominal tolerance mode comprises the at least one angled contact surface of the inner ring contacting an opposing angled contact surface of the lower platform, the at least one contact surface of the outer ring contacting an opposing contact surface of the upper platform, and the fore end of the outer ring contacting a flange of the upper platform.

15. The gas turbine engine of claim 14, wherein the nominal tolerance mode comprises the at least one angled contact surface of the inner ring comprising a first region having a rounded contact surface and a second region having a flat contact surface, the flat contact surface contacting the opposing angled contact surface and preventing axially aftward movement.

16. The gas turbine engine of claim 1, wherein a nominal tolerance mode comprises the at least one angle contact surface of the inner ring comprising a first region having a rounded contact surface and a second region having a flat contact surface, and the flat contact face and opposing angled contact surface contact each other and prevent axially aftward movement.

17. The gas turbine engine of claim 1, further comprising a compressor section, a combustor in fluid communication with the compressor section and the turbine section.
